(19) United States
(12) Patent Application Publication
(10) Pub. No.: US 2026/0177514 A1
(43) Pub. Date: Jun. 25, 2026

(54) METHOD FOR MEASURING DYNAMIC THERMAL EXPANSION PROPERTY OF NANO-FILM

(71) Applicant: Zhejiang Sci-Tech University, Hangzhou City (CN)

(72) Inventors: Biao ZUO, Hangzhou City (CN); Jintian LUO, Hangzhou City (CN); Kun YE, Hangzhou City (CN); Jiachen LI, Hangzhou City (CN)

(21) Appl. No.: 19/078,188

(22) Filed: Mar. 12, 2025

(30) Foreign Application Priority Data
Dec. 24, 2024 (CN) 202411909612.2

(51) Int. Cl. G01N 25/16; G01B 11/06

(52) U.S. Cl. CPC G01N 25/16; G01B 11/06

(57) ABSTRACT

This application provides a method for measuring a dynamic thermal expansion property of a nano-film, and relates to the technical field of measurement. The method is applied to an ellipsometer equipped with a temperature-controlled heating stage. The method includes: controlling a temperature of a film sample on the temperature-controlled heating stage according to a resonant temperature modulation program, and obtaining a thickness-time curve of the film by using the ellipsometer; determining, by using a digital signal processing method based on the obtained thickness-time curve, an amplitude and a phase of a resonant dynamic change generated for a thickness of the film in response to the temperature modulation program, to obtain an amplitude-time curve and a phase-time curve; and further determining a coefficient of apparent thermal expansion, a coefficient of reversible thermal expansion, and a coefficient of irreversible thermal expansion for the film sample.

### CROSS REFERENCE TO RELATED APPLICATION

This application claims the benefit of and priority to Chinese Patent Application No. 202411909612.2, filed Dec. 24, 2024, which is hereby incorporated by reference herein in its entirety.

### TECHNICAL FIELD

The present disclosure relates to the technical field of measurement, and in particular, to a method for measuring a dynamic thermal expansion property of a nano-film.

### BACKGROUND

In recent years, the rapid development of film sample preparation technologies makes it convenient to use an optical film sample to improve device performance. The optical film sample has been widely used in high-tech fields such as information detection, weapons and equipment, aerospace, and new energy due to its unique property, and plays an important role in production and manufacturing of integrated circuits, laser devices, biochips, and liquid crystal displays. Measurement of a property (such as a film thickness, a refractive index, an extinction coefficient, or another optical parameter) of a film sample is an essential step in designing and manufacturing the film sample.

An elliptical polarization spectrometer (ellipsometer) has advantages of fast measurement, large-flux data collection, automated analysis, non-contact, high sensitivity, and non-destruction. As a film sample measurement technology, the elliptical polarization spectrometer is widely used in industrial fields such as semiconductor preparation. An elliptical polarization spectroscopy method (ellipsometry method) adopted by the elliptical polarization spectrometer is a conventional method used to measure the property of the film sample. A basic principle of the elliptical polarization spectroscopy method is to measure a relative amplitude change and a relative phase difference change between two orthogonal polarization components of a light beam reflected or transmitted by the film sample, which are generally represented by symbols Ψ and Δ. The relative amplitude change and the relative phase difference change are results of coherent superposition after a plurality of reflections (or refractions) of the light beam in a film sample system, and carry optical constant information of the film sample. An optical model (for example, a Cauchy's dispersion formula) can be used to obtain the thickness (with resolution up to a sub-nanometer level), the refractive index, and other properties of the film sample through fitting. However, this traditional elliptical polarization spectroscopy method has certain limitations, and cannot distinguish contributions of a reversible change (such as thermal expansion or glass transition) and an irreversible change (such as crystallization, chemical reaction, or degradation) in a property change process of the film sample. Therefore, the classical ellipsometry method is difficult to accurately distinguish various complex transitions, and thus it is difficult to understand and explain an apparent change of the property of the film sample in terms of a microstructure and a molecular motion state of the film sample.

### SUMMARY

An objective of the present disclosure is to provide a method for measuring a dynamic thermal expansion property of a nano-film, which can accurately determine a coefficient of irreversible thermal expansion, as well as a coefficient of reversible thermal expansion and its real and imaginary parts for a film sample by setting a temperature modulation program to measure a thermal expansion behavior of the film sample. This can accurately reflect a microstructure, a molecular motion state, and a thermal relaxation behavior of a nano-film sample.

To achieve the above objective, the present disclosure provides the following technical solutions.

The present disclosure provides a method for measuring a dynamic thermal expansion property of a nano-film, where the method for measuring a dynamic thermal expansion property of a nano-film is applied to an ellipsometer equipped with a temperature-controlled heating stage; the temperature-controlled heating stage is configured to carry a film sample; the temperature-controlled heating stage is also configured to control a temperature of the film sample according to a temperature modulation program; and the temperature modulation program includes a linear temperature change program and a resonant temperature modulation program that are superimposed; and
the method for measuring a dynamic thermal expansion property of a nano-film includes:
controlling the temperature of the film sample on the temperature-controlled heating stage according to the temperature modulation program, to obtain a thickness-time curve of the film sample;
determining an apparent thickness-time curve of the film sample by using a numerical integral averaging formula based on an average temperature and frequency of the temperature modulation program and the thickness-time curve of the film sample;
determining an amplitude-time curve and a phase-time curve of the film sample by using a digital signal processing method based on the average temperature and frequency of the temperature modulation program and the thickness-time curve of the film sample, where both the amplitude-time curve and the phase-time curve are used to describe a resonant dynamic change of a thickness of the film sample in response to resonant temperature modulation;
determining a coefficient of apparent thermal expansion of the film sample under the temperature modulation program by using a numerical derivation formula based on the average temperature and frequency of the temperature modulation program and the apparent thickness-time curve of the film sample;
determining a coefficient of reversible thermal expansion of the film sample under the temperature modulation program by using a formula for the reversible thermal expansion, and real and imaginary parts of the coefficient of the reversible thermal expansion based on the average temperature, the average frequency, an average amplitude, and an average phase of the temperature modulation program, as well as the amplitude-time curve and the phase-time curve of the film sample; and
determining a coefficient of irreversible thermal expansion of the film sample under the temperature modulation program by using a difference formula based on the coefficients of the apparent thermal expansion and the reversible thermal expansion of the film sample.

Optionally, the temperature modulation program is as follows:

$$T ( t ) = {T}_{av} ( t ) + {T}_{dyn} ( t ) ;$$

$${T}_{av} ( t ) = {T}_{0} + qt ;$$

$${T}_{dyn} ( t ) = {A}_{T} sin ( ω t + {φ}_{T} ) ;$$

where T (t) represents the temperature modulation program; Tₐᵥ(t) represents the average temperature, namely the linear temperature change program; T_{dyn}(t) represents the resonant temperature modulation program; T₀ represents a start temperature of the linear temperature change program; q represents a temperature change rate of the linear temperature change program; t represents a time point; A_{T} represents an amplitude of the resonant temperature modulation program; ω represents a frequency of the resonant temperature modulation program, where ω=2π/tₚ, and tₚ represents a cycle of the amplitude of the resonant temperature modulation program; and φ_{T} represents an initial phase of the resonant temperature modulation program.

Optionally, the controlling the temperature of the film sample on the temperature-controlled heating stage according to the temperature modulation program, to obtain a thickness-time curve of the film sample includes:
preparing the film sample;
placing the film sample on the temperature-controlled heating stage, performing optical path alignment, and controlling the temperature of the film sample according to the temperature modulation program;
obtaining an elliptical polarization spectrum of the film sample in a temperature control process, where the elliptical polarization spectrum includes an amplitude ratio spectrum and a phase difference spectrum; and
fitting the elliptical polarization spectrum by using an elliptical polarization spectrometer to obtain the thickness-time curve of the film sample.

Optionally, the numerical integral averaging formula is as follows:

$${h}_{app} ( t ) = \frac{1}{{t}_{p}} {\int }_{t - \frac{{t}_{p}}{2}}^{t + \frac{{t}_{p}}{2}} h ( {t}^{′} ) {dt}^{′} ;$$

where h(t) represents the thickness-time curve, hₐₚₚ(t) represents the apparent thickness-time curve, and t′ represents an integral variable.

Optionally, the digital signal processing method includes a function fitting method, a discrete Fourier transform method, a fast Fourier transform method, or a digital lock-in amplification method.

$${α}_{app} ( t ) = \frac{1}{{qh}_{app} ( t )} \cdot \frac{{dh}_{app} ( t )}{dt} ,$$

Optionally, the numerical derivation formula is: where
αₐₚₚ(t) represents the coefficient of the apparent thermal expansion of the film sample.

Optionally, the determining a coefficient of reversible thermal expansion of the film sample under the temperature modulation program, and real and imaginary parts of the coefficient of the reversible thermal expansion based on the average temperature, the average frequency, an average amplitude, and an average phase of the temperature modulation program, as well as the amplitude-time curve and the phase-time curve of the film sample includes: determining the coefficient of the reversible thermal expansion of the film sample under the temperature modulation program by using the formula for the reversible thermal expansion based on the average temperature, frequency, and amplitude of the temperature modulation program and the amplitude-time curve of the film sample;
determining the real part of the coefficient of the reversible thermal expansion of the film sample under the temperature modulation program by using a real part formula based on the coefficient of the reversible thermal expansion of the film sample and the phase-time curve of the film sample; and
determining the imaginary part of the coefficient of the reversible thermal expansion of the film sample under the temperature modulation program by using an imaginary part formula based on the coefficient of the reversible thermal expansion of the film sample and the phase-time curve of the film sample.

Optionally, the formula for the reversible thermal expansion is:

$${α}_{r} ( t ) = \frac{1}{{h}_{app} ( t )} \cdot \frac{{A}_{h} ( t )}{{A}_{T}} ,$$

where
αᵣ(t) represents the coefficient of the reversible thermal expansion of the film sample, Aₕ(t) represents the amplitude-time curve of the film sample, and A_{T} represents an amplitude of the temperature modulation program.

Optionally, the real part formula is: α′(t)=αᵣ(t)·cos δ(t), where

$$δ ( t ) = {φ}_{T} - {φ}_{h} ( t ) ;$$

where α′(t) represents the real part of the coefficient of the reversible thermal expansion, δ(t) represents an intermediate parameter, φ_{T} represents the initial phase of the resonant temperature modulation program, and φₕ(t) represents the phase-time curve of the film sample; and
the imaginary part formula is: α″(t)=αᵣ(t)·sin δ(t), where
α″(t) represents the imaginary part of the coefficient of the reversible thermal expansion.

Optionally, the difference formula is: αₙᵣ (t)=αₐₚₚ(t)−αᵣ(t), where
αₙᵣ(t) represents the coefficient of the irreversible thermal expansion of the film sample.

According to specific embodiments provided in the present disclosure, the present disclosure achieves the following technical effects:

The present disclosure provides a method for measuring a dynamic thermal expansion property of a nano-film. A resonant temperature modulation program is superimposed to induce a film sample to produce a resonant dynamic thickness change in response to a temperature modulation change. A phase lag between the dynamic thickness change of the sample and the temperature modulation program is obtained through comparison, in order to distinguish coefficients of reversible thermal expansion and irreversible thermal expansion of the film sample in a thermal expansion process, as well as real and imaginary parts of the coefficient of the reversible thermal expansion. The present disclosure is essentially a temperature-modulated elliptical polarization spectroscopy method, which provides a more reliable method for characterizing materials, decomposes a complex transition into easily analyzable components, separates overlapping transitions, improves sensitivity, detects a weak transition, and provides more sufficient information for understanding a property of the film sample and a microscopic nature of a thermal response of the film sample.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a flowchart of a thermal expansion property of a film sample according to an embodiment of the present disclosure;

FIG. 2 shows temperature modulation program-film sample curves according to an embodiment of the present disclosure;

FIG. 3 is a schematic diagram of a sinusoidal temperature modulation program when T=130° C. to 50° C. according to an embodiment of the present disclosure;

FIG. 4 shows an elliptical polarization spectrum of a polymer film sample making a response based on a wavelength at t=5 min according to an embodiment of the present disclosure;

FIG. 5 shows an elliptical polarization spectrum of a polymer film sample making a response based on a wavelength at t=19 min according to an embodiment of the present disclosure;

FIG. 6 is a schematic diagram of film thickness data that is of a polystyrene film sample and measured under a sinusoidal temperature modulation program when T=130° C. to 50° C. according to an embodiment of the present disclosure;

FIG. 7 is a schematic diagram of apparent film thickness data that is of a polystyrene film sample and calculated under a sinusoidal temperature modulation program when T=130° C. to 50° C. according to an embodiment of the present disclosure;

FIG. 8 shows changes of an amplitude and a phase of a dynamic film thickness change of a polystyrene film sample with an average temperature according to an embodiment of the present disclosure;

FIG. 9 shows changes of coefficients of apparent thermal expansion, reversible thermal expansion, and irreversible thermal expansion of a polystyrene film sample with an average temperature according to an embodiment of the present disclosure;

FIG. 10 shows changes of a real part and an imaginary part of a coefficient of reversible thermal expansion of a polystyrene film sample with an average temperature according to an embodiment of the present disclosure;

FIG. 11 is a schematic diagram of a sinusoidal temperature modulation program when T=45° C. to 145° C. according to an embodiment of the present disclosure;

FIG. 12 is a schematic diagram of film thickness data that is of a polyethylene terephthalate film sample and measured under a sinusoidal temperature modulation program when T=45° C. to 145° C. according to an embodiment of the present disclosure;

FIG. 13 is a schematic diagram of apparent film thickness data that is of a polyethylene terephthalate film sample and calculated under a sinusoidal temperature modulation program when T=45° C. to 145° C. according to an embodiment of the present disclosure;

FIG. 14 shows a change of an amplitude of a dynamic film thickness change of a polyethylene terephthalate film sample with an average temperature according to an embodiment of the present disclosure; and

FIG. 15 shows changes of coefficients of apparent thermal expansion, reversible thermal expansion, and irreversible thermal expansion of a polyethylene terephthalate film sample with an average temperature according to an embodiment of the present disclosure.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure more obvious and easy to understand, the present disclosure will be further described in detail with reference to the accompanying drawings and specific implementations.

In an exemplary embodiment, a method for measuring a dynamic thermal expansion property of a nano-film is provided, which is applied to an ellipsometer equipped with a temperature-controlled heating stage. The temperature-controlled heating stage is configured to carry a film sample. The temperature-controlled heating stage is also configured to control a temperature of the film sample according to a temperature modulation program. The temperature modulation program includes a linear temperature change program and a resonant temperature modulation program that are superimposed. The temperature modulation program is as follows:

$$T ( t ) = {T}_{av} ( t ) + {T}_{dyn} ( t ) ;$$

$${T}_{av} ( t ) = {T}_{0} + qt ;$$

$${T}_{dyn} ( t ) = {A}_{T} sin ( ω t + {φ}_{T} ) ;$$

In the above formulas, T (t) represents the temperature modulation program; Tₐᵥ(t) represents an average temperature, namely the linear temperature change program; T_{dyn} (t) represents the resonant temperature modulation program; T₀ represents a start temperature of the linear temperature change program; q represents a temperature change rate of the linear temperature change program; t represents a time point; A_{T} represents an amplitude of the resonant temperature modulation program; ω represents a frequency of the resonant temperature modulation program, where ω=2π/tₚ, and tₚ represents a cycle of the amplitude of the resonant temperature modulation program; and φ_{T} represents an initial phase of the resonant temperature modulation program.

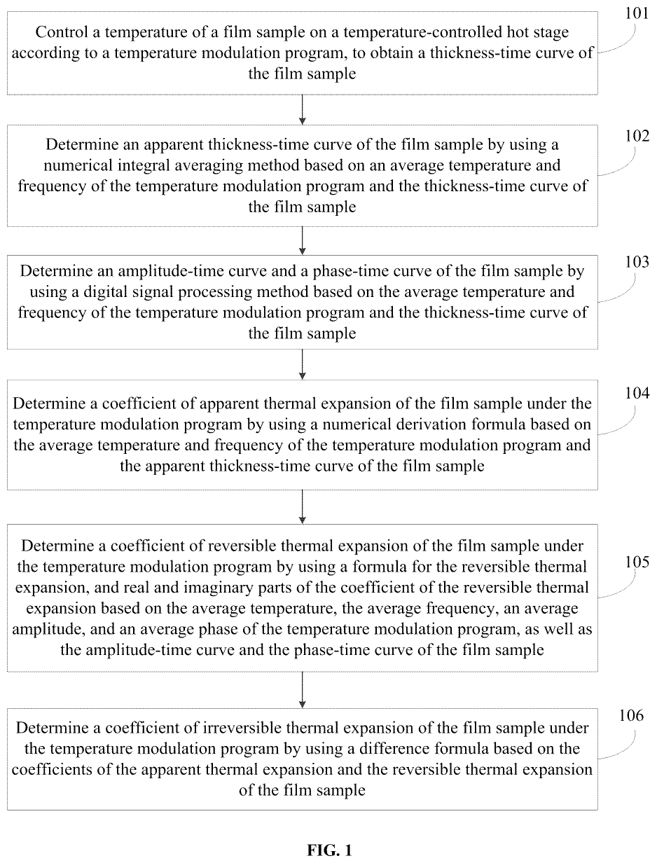

As shown in FIG. 1, the method for measuring a dynamic thermal expansion property of a nano-film includes the following steps:

Step 101: Control the temperature of the film sample on the temperature-controlled heating stage according to the temperature modulation program, to obtain a thickness-time curve of the film sample, where the following operations are included: preparing the film sample; placing the film sample on the temperature-controlled heating stage, performing optical path alignment, and controlling the temperature of the film sample according to the temperature modulation program; obtaining an elliptical polarization spectrum of the film sample in a temperature control process, where the elliptical polarization spectrum includes an amplitude ratio spectrum (λ, t) and a phase difference spectrum Δ(λ, t); and fitting the elliptical polarization spectrum by using an elliptical polarization spectrometer to obtain the thickness-time curve of the optical film sample.

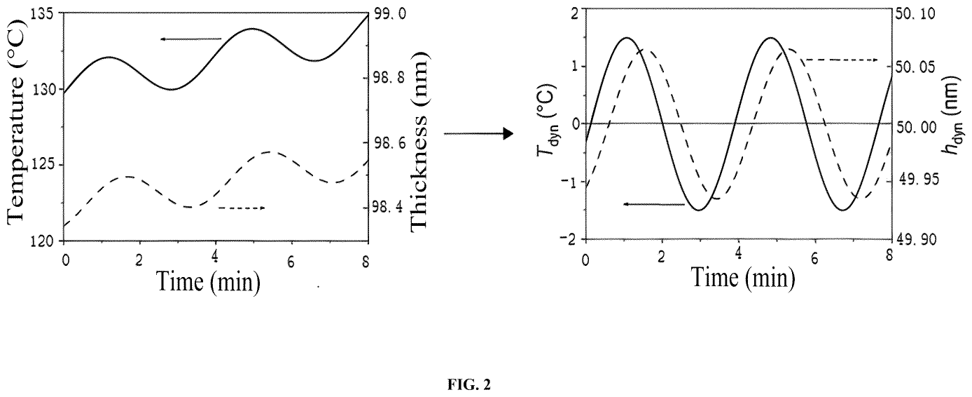

Specifically, the film sample loaded on a surface of a silicon wafer is prepared. The film sample is placed on the temperature-controlled heating stage of the elliptical polarization spectrometer, and necessary optical path alignment is performed. The temperature-controlled heating stage is used to control the temperature of the film sample according to the temperature modulation program (see FIG. 2). In addition, the elliptical polarization spectrometer is used to collect a continuously changing elliptical polarization spectrum of the film sample in real time, in order to obtain a thickness change of the film sample with time. In FIG. 2, the solid line in the left figure represents a temperature curve; the dashed line in the left figure represents the thickness change of the film sample; the solid line in the right figure represents a temperature modulation Tdyn (t) curve; and the dashed line in the left figure represents a generated resonant dynamic change hdyn (t) of a thickness of the film sample in response to the temperature modulation program, which is a difference between the thickness and an apparent thickness (namely, hdyn=h−happ).

A_{T} represents the amplitude of the resonant temperature modulation program; ω represents the frequency of the resonant temperature modulation program, where ω=2π/tₚ, and tₚ represents the cycle of the amplitude of the resonant temperature modulation program; and φ_{T} represents the initial phase of the resonant temperature modulation program; A dynamic response of the thickness (h) of the film sample also is in a sinusoidal form with a frequency of ω, where Ah represents an amplitude of the dynamic response of the thickness, and φh represents an initial phase of the thickness. A phase difference δ between the hdyn (t) and the Tdyn (t) is equal to φT−φh.

Analysis software provided by the elliptical polarization spectrometer is used to fit the amplitude ratio spectrum Ψ(λ, t) and the phase difference spectrum Δ(λ, t) to obtain the generated change of the thickness h(t) of the film sample with the time in response to the temperature modulation program (as shown in FIG. 2). The change includes two contributions: a response to the linear temperature change program in the program; and a dynamic response to the resonant temperature modulation program (which is referred to as a dynamic response), which also exhibits a resonant fluctuation (see FIG. 2).

Step 102: Determine an apparent thickness-time curve of the film sample by using a numerical integral averaging formula based on an average temperature and frequency of the temperature modulation program and the thickness-time curve of the film sample. The numerical integral averaging formula is as follows:

$${h}_{app} ( t ) = \frac{1}{{t}_{p}} {\int }_{t - \frac{{t}_{p}}{2}}^{t + \frac{{t}_{p}}{2}} h ( {t}^{′} ) {dt}^{′} .$$

In the above formula, h(t) represents the thickness-time curve, hₐₚₚ (t) represents the apparent thickness-time curve, and t′ represents an integral variable.

Step 103: Determine an amplitude-time curve and a phase-time curve of the film sample by using a digital signal processing method based on the average temperature and frequency of the temperature modulation program and the thickness-time curve of the film sample. Both the amplitude-time curve and the phase-time curve are used to describe the generated resonant dynamic change of the thickness of the film sample in response to resonant temperature modulation. The digital signal processing method includes a function fitting method, a discrete Fourier transform method, a fast Fourier transform method, or a digital lock-in amplification method.

Further, the following parameters are extracted by using the digital signal processing method:
1. an amplitude that is of the dynamic change of the thickness and corresponds to the frequency ω, and a change Ah(t) of the amplitude with the time; and
2. a phase that is of the dynamic change of the thickness and corresponds to the frequency ω, and a change φh(t) of the phase with the time.

Step 104: Determine a coefficient of apparent thermal expansion of the film sample under the temperature modulation program by using a numerical derivation formula based on the average temperature and frequency of the temperature modulation program and the apparent thickness-time curve of the film sample. The numerical derivation formula is:

$${α}_{app} ( t ) = \frac{1}{{qh}_{app} ( t )} \cdot \frac{{dh}_{app} ( t )}{dt} .$$

In the above formula, αₐₚₚ(t) represents the coefficient of the apparent thermal expansion of the film sample.

Step 105: Determine a coefficient of reversible thermal expansion of the film sample under the temperature modulation program by using a formula for the reversible thermal expansion, and real and imaginary parts of the coefficient of the reversible thermal expansion based on the average temperature, the average frequency, an average amplitude, and an average phase of the temperature modulation program, as well as the amplitude-time curve and the phase-time curve of the film sample, where the following operations are included: determining the coefficient of the reversible thermal expansion of the film sample under the temperature modulation program by using the formula for the reversible thermal expansion based on the average temperature, frequency, and amplitude of the temperature modulation program and the amplitude-time curve of the film sample; determining the real part of the coefficient of the reversible thermal expansion of the film sample under the temperature modulation program by using a real part formula based on the coefficient of the reversible thermal expansion of the film sample and the phase-time curve of the film sample; and determining the imaginary part of the coefficient of the reversible thermal expansion of the film sample under the temperature modulation program by using an imaginary part formula based on the coefficient of the reversible thermal expansion of the film sample and the phase-time curve of the film sample. The formula for the reversible thermal expansion is:

$${α}_{r} ( t ) = \frac{1}{{h}_{app} ( t )} \cdot \frac{{A}_{h} ( t )}{{A}_{T}} .$$

In the above formula, αᵣ (t) represents the coefficient of the reversible thermal expansion of the film sample, Aₕ (t) represents the amplitude-time curve of the film sample, and A_{T} represents an amplitude of the temperature modulation program.

The real part formula is: α′(t)=αᵣ (t)·cos δ(t), where

$$δ ( t ) = {φ}_{T} - {φ}_{h} ( t ) .$$

In the above formula, α′(t) represents the real part of the coefficient of the reversible thermal expansion, δ(t) represents an intermediate parameter, φ_{T} represents the initial phase of the resonant temperature modulation program, and φₕ(t) represents the phase-time curve of the film sample.

The imaginary part formula is: α″(t)=αᵣ (t)·sin δ(t).

In the above formula, α″(t) represents the imaginary part of the coefficient of the reversible thermal expansion.

Step 106: Determine a coefficient of irreversible thermal expansion of the film sample under the temperature modulation program by using a difference formula based on the coefficients of the apparent thermal expansion and the reversible thermal expansion of the film sample.

The difference formula is: αₙᵣ (t)=αₐₚₚ (t)−αᵣ(t).

In the above formula, αₙᵣ (t) represents the coefficient of the irreversible thermal expansion of the film sample.

With reference to the Tav(t), the αₐₚₚ (t), the αᵣ (t), the α′(t), the α″(t), and the αₙᵣ (t), the reversible thermal expansion and the irreversible thermal expansion that are caused by a glass transition, a phase change, a chemical change, and the like of the film sample during a temperature change can be analyzed. The reversible thermal expansion reflects a thermal relaxation behavior of the film sample, the real part corresponds to energy storage of the sample under the temperature programing, and the imaginary part corresponds to energy dissipation. The irreversible thermal expansion reflects the thickness change of the film sample in phase change, chemical reaction, degradation, and other procedures.

In another exemplary embodiment, temperature modulation under a temperature dropping program is provided to measure a glass transition of a film sample.

(1) Select polystyrene (PS) with a molecular weight of 270 kDa and a polymer dispersibility index (PDI) of 1.03, and prepare a film sample with a thickness of 100 nm on a 12 mm×12 mm silicon wafer through spin coating.

(2) Place the sample on a temperature-controlled sample stage (model: Linkam HFSEL600 produced by the United States) of a calibrated elliptical polarization spectrometer (model: J. A. Woollam RC2 produced by the United States), and perform optical path alignment.

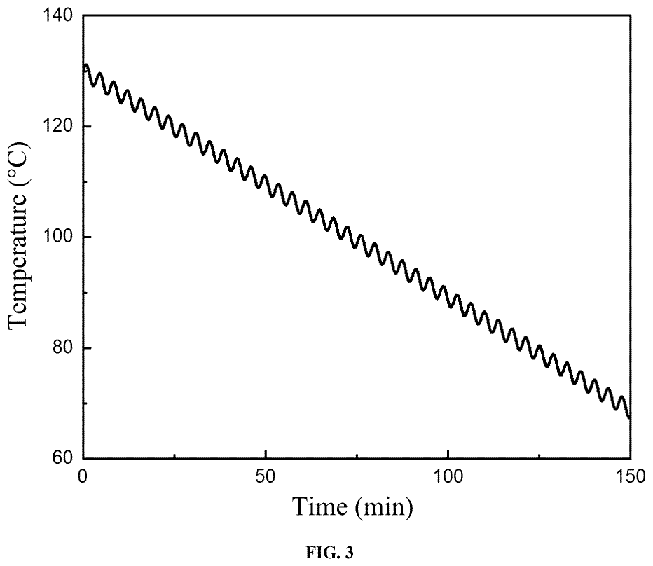

(3) Control a temperature according to temperature programing, with a linear temperature dropping condition being Tav(t)=T0−qt, where a start temperature TO is equal to 130° C., and a linear temperature dropping rate is 0.51° C./min; and for the temperature modulation, a modulation amplitude AT is equal to 1.5° C., and a frequency ω is equal to 2.1 rad/min, namely a cycle tp is equal to 3.00 min, as shown in FIG. 3.

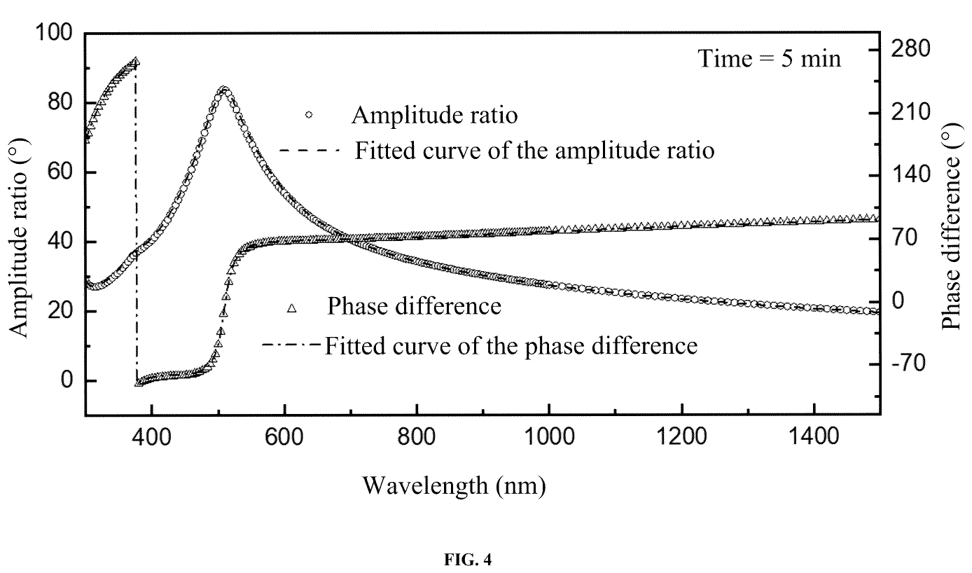

(4) Collected time-resolved elliptical polarization spectra Ψ(λ, t) and Δ(λ, t) are shown in FIG. 4 and FIG. 5. Taking spectra at t=5 min and t=19 min as an example, a wavelength range of the collected spectra is 300 nm to 1500 nm.

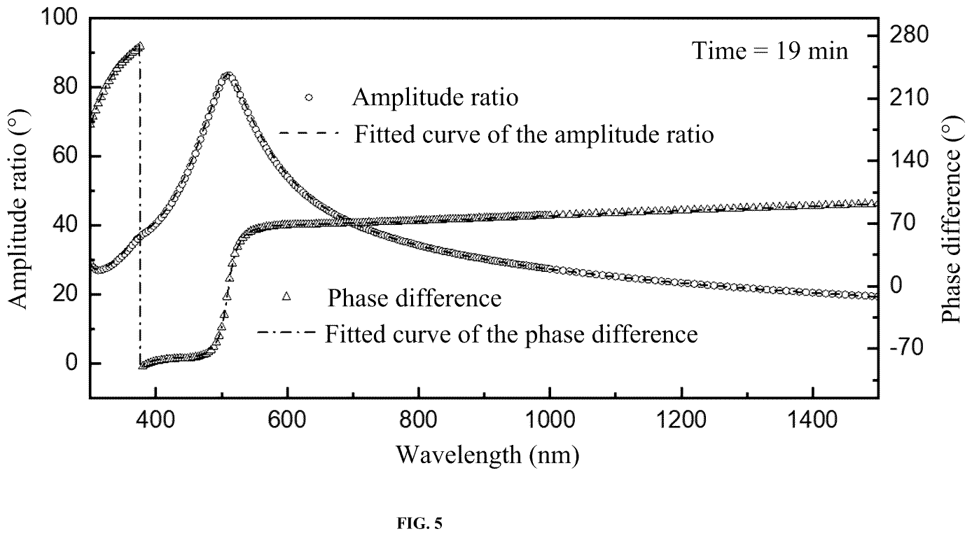

(5) Perform model fitting on the time-resolved elliptical polarization spectra Ψ(λ, t) and Δ(λ, t) to obtain a thickness (h) of the polymer film sample and a change curve of the thickness with time, as shown in FIG. 6.

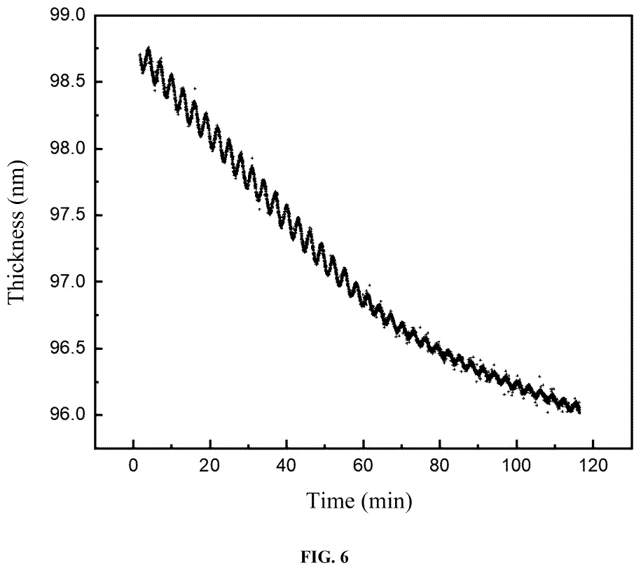

(6) Perform integral averaging on the h(t) in FIG. 6 to obtain an apparent thickness-time curve happ (t), as shown in FIG. 7.

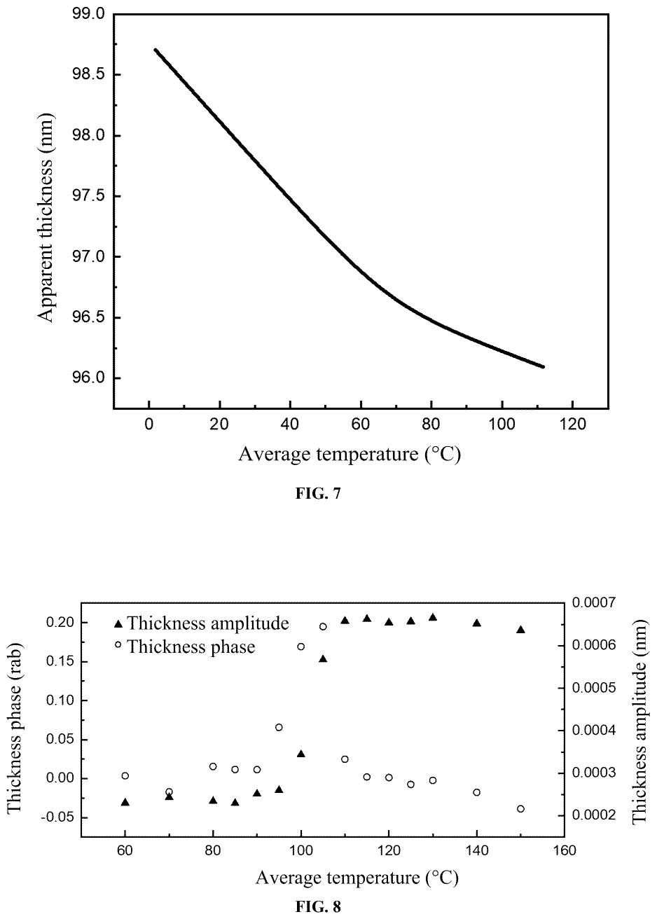

(7) Perform digital signal processing on a dynamic change of the h(t) in FIG. 6 (by using a digital lock-in amplification algorithm in this example) to obtain changes of an amplitude (Ah) and a phase angle (φh) of the h(t) at a frequency of ω=2.09 rad/min with the time or an average temperature (the changes with the time can be converted to the changes with the average temperature based on the Tav(t)), as shown in FIG. 8.

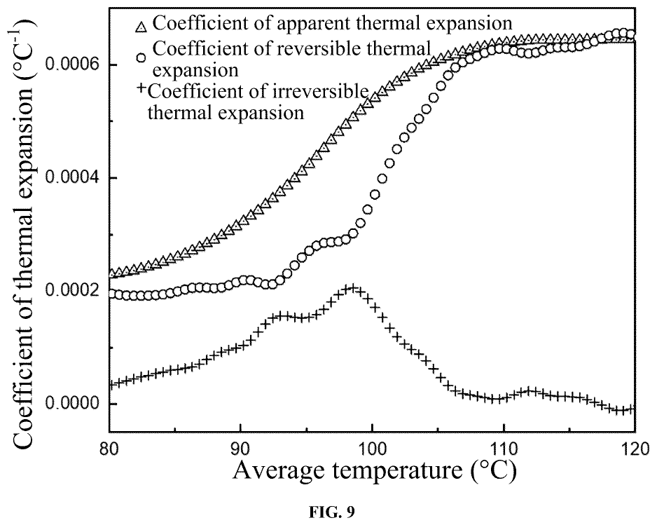

(8) Calculate a change of a coefficient of apparent thermal expansion of the film sample with the average temperature, as well as changes of reversible thermal expansion and irreversible thermal expansion with the average temperature at the frequency of ω=1.67 rad/min, as shown in FIG. 9. It can be seen that at high and low temperatures, the coefficient of the apparent thermal expansion is consistent with the coefficient of the reversible thermal expansion, while the coefficient of the irreversible thermal expansion is close to 0. At a glass transition point, a temperature at which the coefficient of the apparent thermal expansion changes is lower than that at which the coefficient of the reversible thermal expansion changes, which reflects that the coefficient of the apparent thermal expansion corresponds to a static response to linear temperature rising and is sensitive to a heat history and other factors, and that the coefficient of the reversible thermal expansion reflects a thermal relaxation behavior of the sample at a time scale of tp.

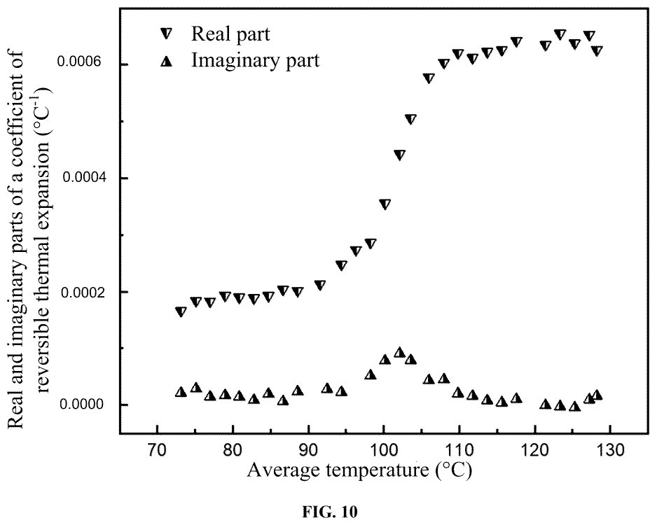

(9) Calculate changes of a real part and an imaginary part of the coefficient of the reversible thermal expansion of the film sample with the average temperature, as shown in FIG. 10. It can be seen that when the temperature drops to about 110° C., α′ begins to decrease from 0.00065° C.−1 to 0.00021° C.−1 in a stepped manner, which corresponds to a glass transition of the PS film sample and a resulting expansion coefficient change. In addition, at 100° C. to 110° C., α″ exhibits a peak, which corresponds to internal friction dissipation caused by the glass transition of the film sample.

In another exemplary embodiment, temperature modulation under a temperature rising program is provided to measure a cold crystallization behavior of a film sample.

(1) Select polyethylene terephthalate (PET) with a weight-average molecular weight of 30 kDa and a PDI of 1.87 as a to-be-tested sample, and prepare a uniform film sample with a thickness of 330 nm on a 12 mm×12 mm silicon wafer through spin coating.

(2) Use an elliptical polarization spectrometer (RC2) with a Linkam temperature-controlled heating stage to control a temperature according to a temperature program shown in the formula 1, with a linear temperature rising condition in this example being Tav(t)=T0+qt, where a start temperature T0 is equal to 45° C., and a linear temperature rising rate is 0.68° C./min; and for the temperature modulation, a modulation amplitude AT is equal to 1.5° C., and a frequency ω is equal to 2.7 rad/min, namely a cycle tp is approximately equivalent to 2.3 min, as shown in FIG. 11.

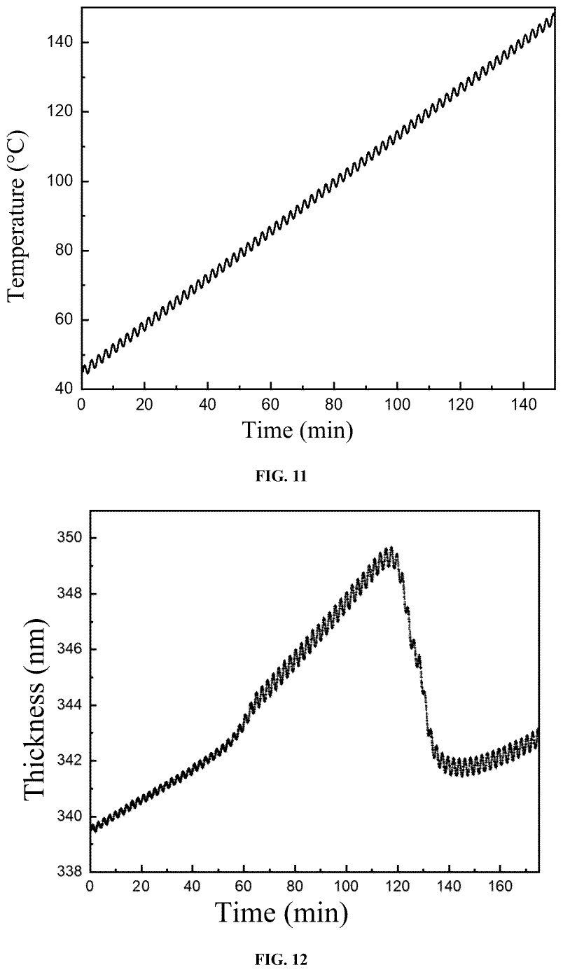

(3) Perform model fitting on collected time-resolved elliptical polarization spectra Ψ(λ, t) and Δ(λ, t) to obtain a change curve h(t) of a thickness of the film sample with time, as shown in FIG. 12.

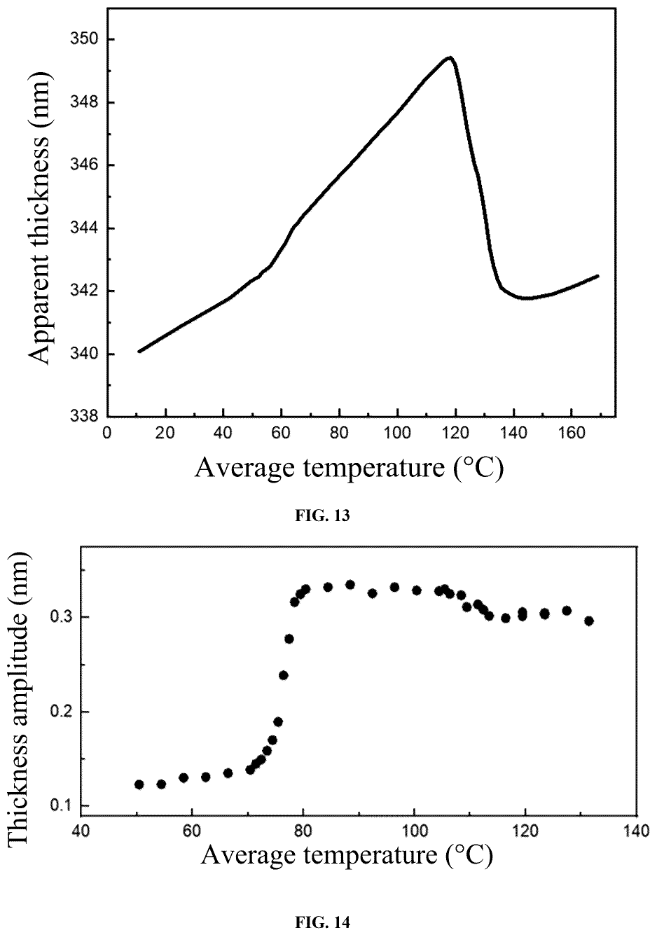

(4) Perform integral averaging on the h(t) in FIG. 12 to obtain an apparent thickness-time curve happ (t), as shown in FIG. 13.

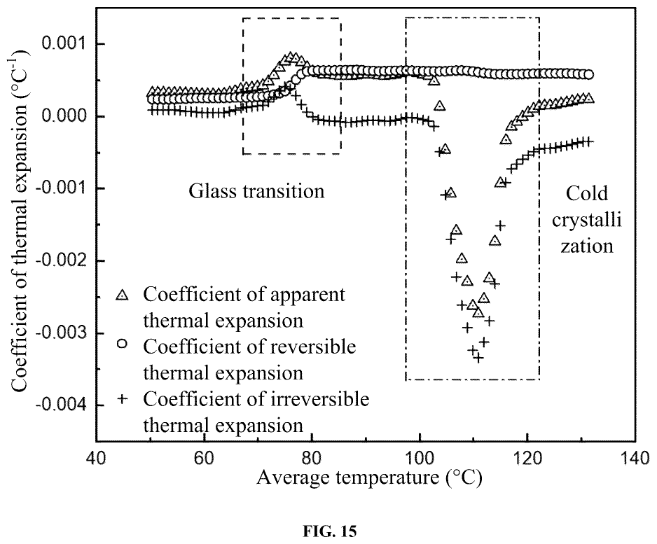

(5) Perform digital signal processing on a dynamic change of the h(t) in FIG. 12 (by using a digital lock-in amplification algorithm in this example) to obtain a change of an amplitude (Ah) of the h(t) at a frequency of ω=2.7 rad/min with time or an average temperature (the change with the time can be converted to the change with the average temperature based on the Tav(t)), as shown in FIG. 14.

(6) Calculate a change of a coefficient of apparent thermal expansion of the film sample with the average temperature, as well as changes of reversible thermal expansion and irreversible thermal expansion with the average temperature at the frequency of ω=2.7 rad/min, as shown in FIG. 15. It can be seen that when the temperature rises to about 70° C., the coefficient of the reversible thermal expansion rises from 0.00024° C.−1 to 0.00064° C.−1 in a stepped manner, which corresponds to a glass transition of the PET film sample and a resulting change of a thermal expansion behavior. In addition, at 70° C. to 80° C., the coefficient of the irreversible thermal expansion exhibits a peak, which corresponds to an effect resulting from a heat history of the film sample. In addition, when the temperature rises to above 90° C., the coefficient of the reversible thermal expansion drops again, from 0.00064° C.−1 to 0.00056° C.−1, which corresponds to a decrease in a coefficient of thermal expansion due to cold crystallization of the PET film sample. In addition, the coefficient of the irreversible thermal expansion exhibits another peak, which corresponds to irreversible volume shrinkage of the film sample due to the cold crystallization (as shown in FIG. 13).

In an exemplary embodiment, a computer device is provided. The computer device may be a server or a terminal. The computer device includes a processor, a memory, an input/output (I/O) interface, and a communication interface. The processor, the memory, and the I/O interface are connected through a system bus. The communication interface is connected to the system bus through the I/O interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for running the operating system and the computer program in the non-volatile storage medium. The I/O interface of the computer device is configured to exchange information between the processor and an external device. The communication interface of the computer device is configured to connect to and communicate with an external terminal through a network. The computer program is executed by the processor to implement a method for measuring a dynamic thermal expansion property of a nano-film.

In an exemplary embodiment, a computer-readable storage medium is provided. The computer-readable storage medium stores a computer program, and the computer program is executed by a processor to implement the steps of the above method embodiments.

In an exemplary embodiment, a computer program product is provided, including a computer program. The computer program is executed by a processor to implement the steps of the above method embodiments.

It should be noted that information of a user (including but not limited to device information of the user, personal information of the user, and the like) and data (including but not limited to data for analysis, stored data, displayed data, and the like) in the present disclosure are information and data authorized by the user or fully authorized by each party, and relevant data shall be acquired, used and processed according to relevant regulations.

Those of ordinary skill in the art may understand that all or some of the procedures in the method of the foregoing embodiments may be implemented by a computer program instructing related hardware. The computer program may be stored in a non-volatile computer-readable storage medium. When the computer program is executed, the procedures in the embodiments of the foregoing method may be performed. Any reference to a memory, a database, or other media used in the embodiments of the present disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache memory, or the like. As an illustration rather than a limitation, the RAM may be in various forms, such as a static random access memory (SRAM) or a dynamic random access memory (DRAM).

The database in the embodiments of the present disclosure may include at least one of a relational database and a non-relational database. The non-relational database may include a blockchain-based distributed database, but is not limited thereto. The processor in the embodiments of the present disclosure may be a general processor, a central processing unit (CPU), a graphics processor, a digital signal processor (DSP), a programmable logic device, and a data processing logic device based on quantum computing, but is not limited thereto.

The technical characteristics of the above embodiments can be employed in arbitrary combinations. For brevity of description, all possible combinations of all the technical characteristics of the above embodiments may not be described; however, these combinations of the technical characteristics should be construed as falling within the scope defined by the specification as long as no contradiction occurs.

Specific examples are used herein for illustration of the principles and implementations of the present disclosure. The description of the foregoing embodiments is used to help illustrate the method of the present disclosure and the core principles thereof. In addition, those of ordinary skill in the art can make various modifications in terms of specific implementations and a scope of application in accordance with the teachings of the present disclosure. In conclusion, the content of the specification shall not be construed as a limitation to the present disclosure.

What is claimed is:

1. A method for measuring a dynamic thermal expansion property of a nano-film, wherein the method for measuring a dynamic thermal expansion property of a nano-film is applied to an ellipsometer equipped with a temperature-controlled heating stage; the temperature-controlled heating stage is configured to carry a film sample; the temperature-controlled heating stage is also configured to control a temperature of the film sample according to a temperature modulation program; and the temperature modulation program comprises a linear temperature change program and a resonant temperature modulation program that are superimposed; and
the method for measuring a dynamic thermal expansion property of a nano-film comprises:
controlling the temperature of the film sample on the temperature-controlled heating stage according to the temperature modulation program, to obtain a thickness-time curve of the film sample;
determining an apparent thickness-time curve of the film sample by using a numerical integral averaging formula based on an average temperature and frequency of the temperature modulation program and the thickness-time curve of the film sample;
determining an amplitude-time curve and a phase-time curve of the film sample by using a digital signal processing method based on the average temperature and frequency of the temperature modulation program and the thickness-time curve of the film sample, wherein both the amplitude-time curve and the phase-time curve are used to describe a resonant dynamic change of a thickness of the film sample in response to resonant temperature modulation;
determining a coefficient of apparent thermal expansion of the film sample under the temperature modulation program by using a numerical derivation formula based on the average temperature and frequency of the temperature modulation program and the apparent thickness-time curve of the film sample;
determining a coefficient of reversible thermal expansion of the film sample under the temperature modulation program by using a formula for the reversible thermal expansion, and real and imaginary parts of the coefficient of the reversible thermal expansion based on the average temperature, the average frequency, an average amplitude, and an average phase of the temperature modulation program, as well as the amplitude-time curve and the phase-time curve of the film sample; and
determining a coefficient of irreversible thermal expansion of the film sample under the temperature modulation program by using a difference formula based on the coefficients of the apparent thermal expansion and the reversible thermal expansion of the film sample.

2. The method for measuring a dynamic thermal expansion property of a nano-film according to claim 1, wherein the temperature modulation program is as follows:
$$T ( t ) = {T}_{av} ( t ) + {T}_{dyn} ( t ) ;$$
$${T}_{av} ( t ) = {T}_{0} + qt ;$$
$${T}_{dyn} ( t ) = {A}_{T} sin ( ω t + {φ}_{T} ) ;$$
wherein T (t) represents the temperature modulation program; Tₐᵥ(t) represents the average temperature; T_{dyn} (t) represents the resonant temperature modulation program; T₀ represents a start temperature of the linear temperature change program; q represents a temperature change rate of the linear temperature change program; t represents a time point; A_{T} represents an amplitude of the resonant temperature modulation program; ω represents a frequency of the resonant temperature modulation program, wherein ω=2π/tₚ, and tₚ represents a cycle of the amplitude of the resonant temperature modulation program; and φ_{T} represents an initial phase of the resonant temperature modulation program.

3. The method for measuring a dynamic thermal expansion property of a nano-film according to claim 1, wherein the controlling the temperature of the film sample on the temperature-controlled heating stage according to the temperature modulation program, to obtain a thickness-time curve of the film sample comprises:
preparing the film sample;
placing the film sample on the temperature-controlled heating stage, performing optical path alignment, and controlling the temperature of the film sample according to the temperature modulation program;
obtaining an elliptical polarization spectrum of the film sample in a temperature control process, wherein the elliptical polarization spectrum comprises an amplitude ratio spectrum and a phase difference spectrum; and
fitting the elliptical polarization spectrum by using an elliptical polarization spectrometer to obtain the thickness-time curve of the film sample.

4. The method for measuring a dynamic thermal expansion property of a nano-film according to claim 2, wherein the numerical integral averaging formula is as follows:
$${h}_{app} ( t ) = \frac{1}{{t}_{p}} {\int }_{t - \frac{{t}_{p}}{2}}^{t + \frac{{t}_{p}}{2}} h ( {t}^{′} ) {dt}^{′} ;$$
wherein h(t) represents the thickness-time curve, hₐₚₚ (t) represents the apparent thickness-time curve, and t′ represents an integral variable.

5. The method for measuring a dynamic thermal expansion property of a nano-film according to claim 1, wherein the digital signal processing method comprises a function fitting method, a discrete Fourier transform method, a fast Fourier transform method, or a digital lock-in amplification method.

6. The method for measuring a dynamic thermal expansion property of a nano-film according to claim 4, wherein the numerical derivation formula is:
$${α}_{app} ( t ) = \frac{1}{{qh}_{app} ( t )} \cdot \frac{{dh}_{app} ( t )}{dt} ,$$
wherein
αₐₚₚ (t) represents the coefficient of the apparent thermal expansion of the film sample.

7. The method for measuring a dynamic thermal expansion property of a nano-film according to claim 6, wherein the determining a coefficient of reversible thermal expansion of the film sample under the temperature modulation program, and real and imaginary parts of the coefficient of the reversible thermal expansion based on the average temperature, the average frequency, an average amplitude, and an average phase of the temperature modulation program, as well as the amplitude-time curve and the phase-time curve of the film sample comprises:
determining the coefficient of the reversible thermal expansion of the film sample under the temperature modulation program by using the formula for the reversible thermal expansion based on the average temperature, frequency, and amplitude of the temperature modulation program and the amplitude-time curve of the film sample;
determining the real part of the coefficient of the reversible thermal expansion of the film sample under the temperature modulation program by using a real part formula based on the coefficient of the reversible thermal expansion of the film sample and the phase-time curve of the film sample; and
determining the imaginary part of the coefficient of the reversible thermal expansion of the film sample under the temperature modulation program by using an imaginary part formula based on the coefficient of the reversible thermal expansion of the film sample and the phase-time curve of the film sample.

8. The method for measuring a dynamic thermal expansion property of a nano-film according to claim 7, wherein the formula for the reversible thermal expansion is:
$${α}_{r} ( t ) = \frac{1}{{h}_{app} ( t )} \cdot \frac{{A}_{h} ( t )}{{A}_{T}} ,$$
wherein
αᵣ(t) represents the coefficient of the reversible thermal expansion of the film sample, Aₕ(t) represents the amplitude-time curve of the film sample, and A_{T} represents an amplitude of the temperature modulation program.

9. The method for measuring a dynamic thermal expansion property of a nano-film according to claim 8, wherein the real part formula is: α′(t)=αᵣ(t)·cos δ(t), wherein
δ(t)=φ_{T}−φₕ(t);
wherein α′(t) represents the real part of the coefficient of the reversible thermal expansion, δ(t) represents an intermediate parameter, φ_{T} represents the initial phase of the resonant temperature modulation program, and φₕ(t) represents the phase-time curve of the film sample; and
the imaginary part formula is: α″(t)=αᵣ (t)·sin δ(t), wherein
α″(t) represents the imaginary part of the coefficient of the reversible thermal expansion.

10. The method for measuring a dynamic thermal expansion property of a nano-film according to claim 9, wherein the difference formula is: aₙᵣ (t)=αₐₚₚ (t)−αᵣ (t), wherein
αₙᵣ (t) represents the coefficient of the irreversible thermal expansion of the film sample.
